(19) United States
(12) Patent Application Publication
(10) Pub. No.: US 2026/0227003 A1
(43) Pub. Date: Aug. 6, 2026

(54) METHODS AND SYSTEMS ASSOCIATED WITH A MOUNT AND AN ADAPTER FOR A SENSOR FOR FRACTURING OPERATIONS

(71) Applicant: Commando Pressure Control, Inc., Houston, TX (US)

(72) Inventors: Joseph Boyd, Katy, TX (US); David Tyroch, Houston, TX (US)

(73) Assignee: Commando Pressure Control, Inc., Houston, TX (US)

(21) Appl. No.: 19/458,249

(22) Filed: Jan. 23, 2026

Related U.S. Application Data
(60) Provisional application No. 63/754,809, filed on Feb. 6, 2025.

(51) Int. Cl. F16K 37/00

(52) U.S. Cl. CPC F16K 37/0058; F16K 37/0083

(57) ABSTRACT

A mount that is configured to be coupled to a protective stem housing of a gate valve, an adapter that is configured to be coupled to the mount, and a sensor that is configured to be externally coupled to the adapter. This allows the sensor to be mounted, via that adapter, and mount on any existing model, type, brand, etc. of gate valve.

### BACKGROUND INFORMATION

### Field of the Disclosure

Examples of the present disclosure relate to methods and systems associated with an adapter configured to allow a sensor to be externally mounted on the adapter, wherein the adapter is externally secured to a mount. More specifically, the adapter may allow for a sensor configured to determine whether a valve is open or closed based on a time delay for a signal emitted from the sensor to bounce off a surface of a stem and return to the sensor, allowing the adapter to be retrofitted on existing zipper manifolds via the mount.

### Background

In the oil and gas industry, different companies utilize different equipment on frac trees, which includes different valves, pumps, etc. This requires each vendor to have different embedded sensors to determine if gates are open or closed.

A gate valve is a valve that opens and closes by lifting a barrier out of the path of the fluid. Common gate valves are actuated by a threaded stem that connects the actuator (e.g. handwheel or motor) to the gate. Currently, there are no solutions to retrofit a sensor to determine if the gate is fully closed or open. Companies are forced to utilize specialized equipment or be reactive after the gate valve has failed, rather than being proactive to determine if there is a problem in advance. This compromises the safety of the field operator, the functionality of the gate valve, or the efficiency of a process carried out at the wellhead equipment.

Accordingly, needs exist for systems and methods for a sensor configured to determine whether a valve is open or closed, wherein the sensor is externally mounted on an adapter allowing the adapter to be retrofitted on existing zipper manifolds.

### SUMMARY

Embodiments described herein disclose a mount that is configured to be coupled to a protective stem housing of a gate valve, an adapter that is configured to be externally coupled to the mount, and a sensor that is configured to be externally coupled to the adapter. This allows the sensor to be mounted, via the adapter, and mounted to any existing gate valve model or type.

The mount may be a substantially tubular device that is configured to be positioned over a protective stem housing of a gate valve. The mount may have a tapered first end, a first inner diameter, and a second inner diameter.

The tapered first end may be configured to allow the mount to slide over the protective stem housing and act as a guide during installation.

The first inner diameter may have a first diameter and may have planar-flush sidewalls. This may allow the first inner diameter to encompass the stem housing of the gate valve. The first inner diameter may have a series of radial bolt holes that are configured to receive a bolt, screw, or other coupling mechanisms. Responsive to inserting bolts through the bolt holes, the first inner diameter may be secured to the outer diameter of the protective stem housing.

The second inner diameter may have a second diameter, which is smaller than the first diameter and may be threaded. The threads on the mount may be configured to receive threads on a proximal end of the adapter to couple the adapter with the mount.

The adapter may be a device that is configured to be externally mounted onto the mount. The adapter may include a proximal end that is configured to be coupled with the second inner diameter of the mount, and may have a threaded distal end that is configured to receive threads of a sensor. The proximal end of the adapter may have a threaded outer diameter, wherein the threads on the proximal end correspond with threads on the second diameter of the mount. This may enable the proximal end to be threaded into the second diameter of the mount. The distal end of the adapter may include a threaded inner diameter that is configured to receive threads on the sensor.

The sensor may be configured to be externally mounted on the adapter. The sensor may be configured to emit a signal, measure the time the signal takes to bounce off the stem of the gate valve, and back to the sensor to determine the distance from the sensor to the base of the stem. The sensor may be configured to transmit a signal from a passageway through the adapter, through the first diameter of the mount, into the gate valve assembly, until the signal bounces off an upper surface of the stem of the gate valve, and returns to the sensor. Due to the positioning of the gate valve assembly being different when the gate valve is opened or closed, the time delay to complete this process may also be different when the gate valve is opened or closed. Based on the time delay to complete this process, an operator may determine the position of the valve. As the valve travels between its open and closed positions, the sensor measures the distance and relays the distance data back to the user digitally in a safe environment, so the operator knows the position of the valve from a position of safety. In embodiments, the sensor may determine that the gate valve is in the closed position if the amount of time the signal takes to bounce off the stem of the gate valve is above a first threshold, and the sensor may determine that the gate valve is in the open position if the amount of time the signal takes to bounce off the stem of the gate valve is below the first threshold.

In further embodiments, a light indicator may be mounted on an exterior surface of the sensor. The light indicator may be a first color when the gate valve is in a closed position and a second color when the gate valve is in an open position.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions, or rearrangements may be made within the scope of the invention, and the invention includes all such substitutions, modifications, additions, or rearrangements.

### BRIEF DESCRIPTION OF THE DRAWINGS

Non-limiting and non-exhaustive embodiments of the present invention are described concerning the following figures, wherein reference numerals refer to like parts throughout the various views unless otherwise specified.

FIG. 1 depicts a mount for a sensor, according to an embodiment.

FIG. 2 depicts a cross-sectional view of the mount for the sensor, according to an embodiment.

FIG. 3 depicts an adapter for the assembly, according to an embodiment.

FIG. 4 depicts a cross-sectional view of the adapter, according to an embodiment.

FIG. 5 depicts a protective sleeve for the assembly, according to an embodiment.

FIG. 6 depicts an embodiment of the assembly coupled to a protective stem housing, according to an embodiment.

FIG. 7 illustrates a method for allowing an adapter to be retrofitted on existing zipper manifolds via a mount, according to an embodiment.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present disclosure. Also, common but well-understood elements that are useful or necessary in a commercially feasible embodiment are often not depicted to facilitate a less obstructed view of these various embodiments of the present disclosure.

### DETAILED DESCRIPTION

In the following description, numerous specific details are outlined to provide a thorough understanding of the present invention. It will be apparent, however, to one having ordinary skill in the art that the specific detail need not be employed to practice the present invention. In other instances, well-known materials or methods have not been described in detail to avoid obscuring the present invention.

Embodiments are directed towards an adapter that enables a sensor to be mounted onto any existing gate valve model or type via the adapter and mount. As the valve moves linearly between its open and closed positions, the sensor measures the distance and digitally relays this information to the operator in a safe environment. This ensures the operator can determine the valve’s position remotely.

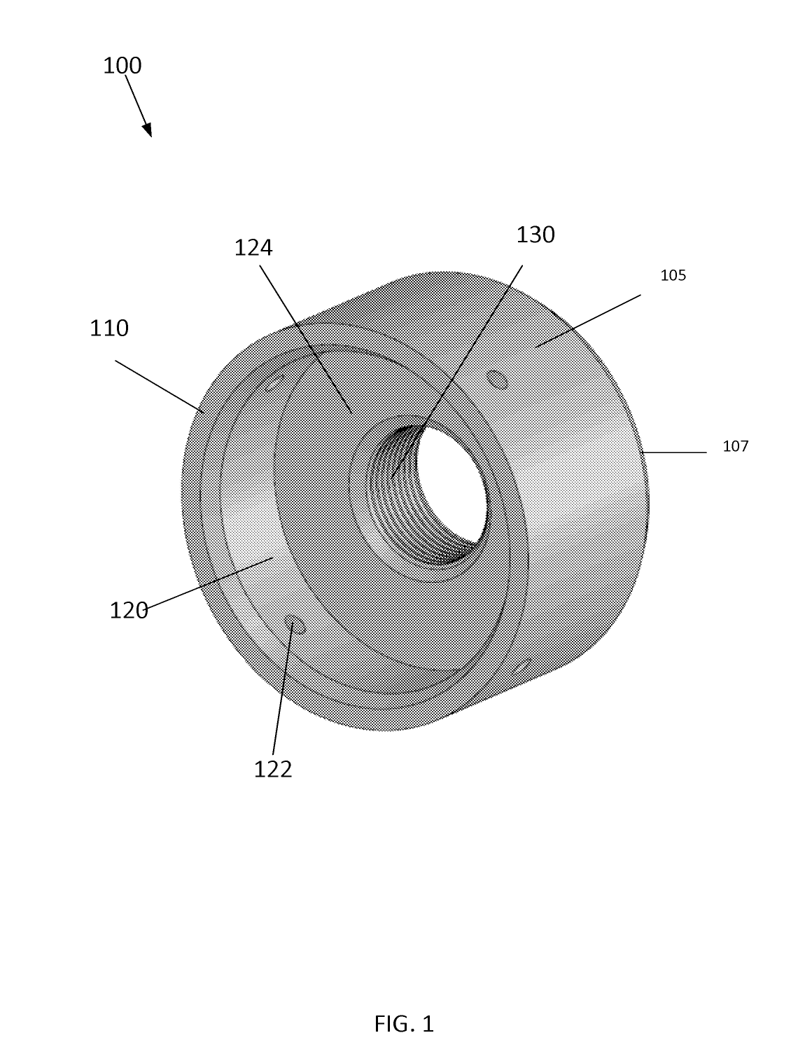

FIG. 1 depicts a mount 100, according to an embodiment. Mount 100 may be a substantially tubular device configured to be positioned over a protective stem housing a gate valve to encompass the protective stem housing. Mount 100 may include a tapered first end 110, a first inner diameter 120, and a second inner diameter 130.

Mount 100 may have a substantially constant exterior circumference 105. However, the distal end of mount 100 may have a tapered exterior 107, wherein reduces the exterior circumference 105.

The tapered first end 110 may be configured to allow the mount 100 to slide over the protective stem housing and to act as a guide while the tapered first end 110 is sliding over the protective stem housing.

The first inner diameter 120 may extend from the tapered first end 110 to an internal ledge 124. The first inner diameter 120 may have flush, planar, smoother, etc. sidewalls, which allow the first inner diameter 120 to be positioned radially adjacent to the protective stem housing.

The first inner diameter 120 may have a series of radial bolt holes 122. Each of the radial bolt holes 122 is configured to receive a bolt, screw, or other coupling mechanisms. Responsive to inserting bolts through the bolt holes 122, the first inner diameter 120 may be secured to the outer diameter of the protective stem housing, wherein the bolts may reduce the distance across the first inner diameter 120. In embodiments, the bolts may be configured to allow mount 100 to be positioned over any sized protective stem housing because the bolts may be utilized to dynamically reduce the circumference across the first inner diameter 120.

Internal ledge 124 may be a shelf, platform, etc. that extends perpendicularly to the sidewalls of the first inner diameter 120. Internal ledge 124 may be configured to be positioned directly adjacent, and in contact with the proximal end of the protective stem housing.

The second inner diameter 130 may be extended from the internal ledge 124 to the distal end of mount 110. The second inner diameter 130 may be threaded, which may allow an adapter to be externally coupled to mount 110. A length of a second inner diameter 130 may be shorter than the length of a first inner diameter 120.

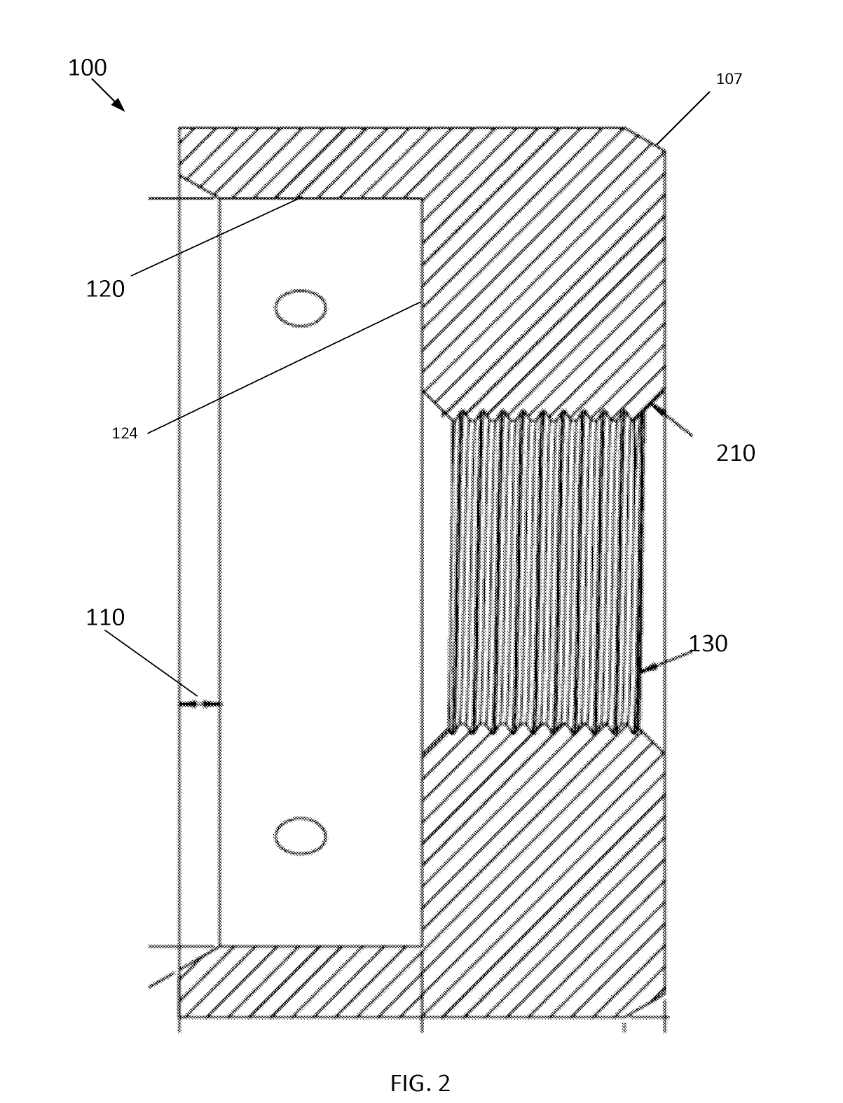

FIG. 2 depicts a cross-sectional view of mount 100, according to an embodiment. Elements depicted in FIG. 2 may be described above, and for the sake of brevity, a further description of these elements may be omitted.

As depicted in FIG. 2, the distal end of mount 100 may include an internal taper 210. The taper 210 may act as a guide to receive the adapter.

As further depicted by FIG. 2, the first inner diameter 120 and second inner diameter 130 may be positioned along the same central axis of the mount 100. This may enable a sensor to emit a light through mount 100.

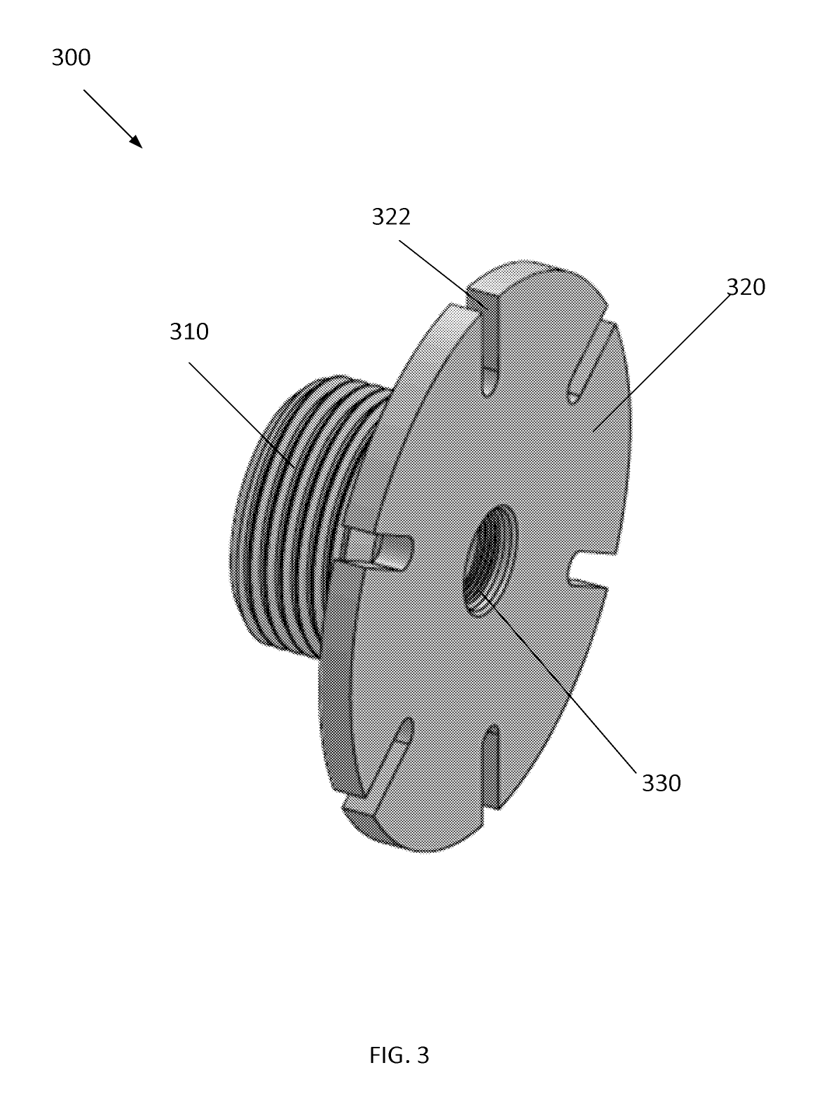

FIG. 3 depicts an adapter 300, according to an embodiment. Adapter 300 may be a device that is configured to be externally mounted onto the mount 100, and configured to allow a sensor to be externally mounted on the adapter 300. Adapter 300 may include a threaded proximal end 310, disc 320, and a threaded distal end 330.

The threaded proximal end 310 may be threads extending from an inner surface of disc 320 to the proximal end of adapter 300, wherein the threads are positioned on an outer diameter of adapter 300. The threaded proximal end 310 may be configured to be threaded into the second inner diameter 130 of the mount 100 to couple the adapter 300 and the mount 100. In embodiments, a diameter across threaded proximal end 310 may be larger than a diameter across threaded distal end 330.

Disc 320 may be a platform, ledge, thin circular object, etc. with a flat inner surface and a flat outer surface. When adapter 300 is coupled to mount 100, the inner surface of disc 320 may be configured to be positioned on an external surface of mount 100. The circumference of disc 320 may include a series of grooves 322, indentations, etc., which extend from an outer circumference of disc 320 towards the center of disc 320. The grooves 322 may allow an operator to hand-tighten the threaded proximal end 330 into the second inner diameter 130 of the mount 100.

The threaded distal end 330 may be a threaded groove positioned on a distal end of adapter 300, wherein the threads are positioned internally within disc 320. The threaded distal end 330 may be configured to receive threads on a sensor. This may allow the sensor to be externally mounted on adapter 300. In different embodiments, the sizing of the threads across the distal end 330 may be different to accommodate different types of sensors. This may allow different sensors to be externally coupled to threaded distal end 330. In embodiments, a diameter across threaded distal end 330 may be smaller than that of threaded proximal end 310.

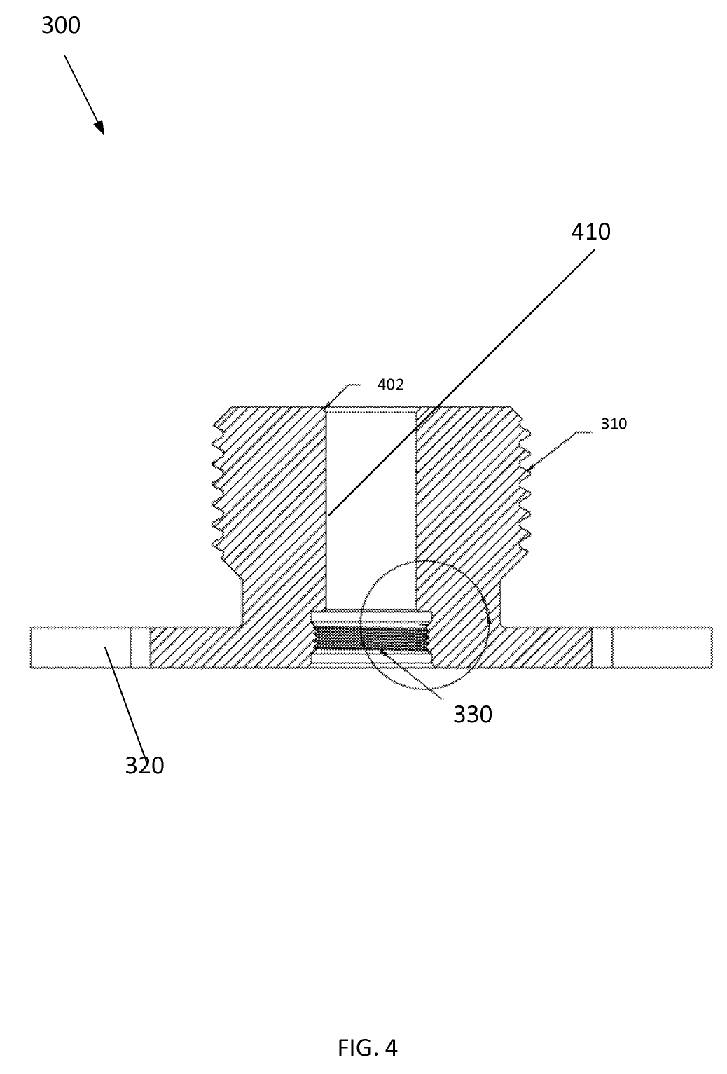

FIG. 4 depicts a cross-sectional view of adapter 300, according to an embodiment. Elements depicted in FIG. 4 may be described above, and for the sake of brevity, a further description of these elements may be omitted.

As depicted in FIG. 4, adapter 300 may have an internal passageway 410 extending from an end of the threaded distal end 330 to the proximal end of adapter 300, wherein the passage may have a tapered inner proximal end 402. When a sensor is externally coupled to the threaded distal end 330, the sensor may emit a light through the passageway 410. The emitted light may bounce off an upper surface of a stem of the gate valve, and return to the sensor via the passageway 410. The distance from the sensor to the stem may be calculated based on the time of the round-trip of the emitted light. This may assist in determining if the gate valve is open or closed based on the distance from the sensor to the stem. In embodiments, the sensor may directly communicate the distance data to a controller.

The sensor may also include a light indicator externally mounted on the sensor, adapter 300, or mount 100. If the sensor data indicates that the distance from the sensor to the stem is above a first threshold, the light indicator may emit a first color light. If the sensor data indicates that the distance from the sensor to the stem is below the first threshold, the light indicator may emit a second color light.

In specific embodiments, the sensor may not continuously monitor the distance from the sensor to the stem. In embodiments, the sensor may be configured to monitor the sensor to the stem based on the sensor receiving an indicator that an actuator has performed an action to open or close a gate.

In further embodiments, the sensor may include a button, trigger, etc., that is configured to be in contact with the stem when the stem is in the open position. Responsive to the gate transitioning from the open position to the closed position, the button may be elongated allowing the sensor to measure a distance from the configured point to monitor the distance from the sensor to the stem, responsive to the stem no longer contacting the button. This may conserve power by not requiring the sensor to continuously monitor the stem when the gate is in the open position, and by contacting the button.

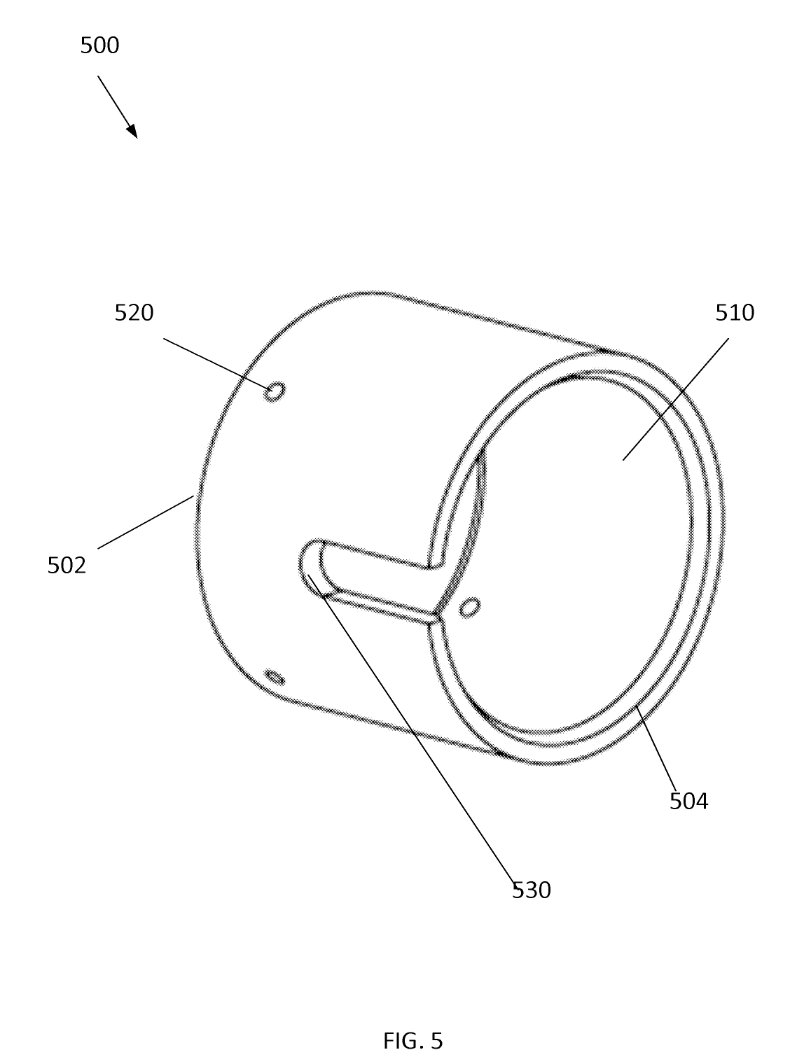

FIG. 5 depicts a protective sleeve 500, according to an embodiment. Protective sleeve 500 may be configured to be slid over the outer diameter of mount 100 to protect an externally coupled sensor. Protective sleeve 500 may have an open inner face 502 and an open outer face 504. Inner circumference 510 may extend from open inner face 502 to open outer face 504 and have a substantially uniform diameter, which may enable inner circumference 510 to be slid over a mount 100.

Bolt holes 520 may extend from an outer circumference of protective sleeve 500 to an inner circumference 510 of protective sleeve 500, and may be configured to receive bolts. When bolts are inserted into bolt holes 520 an inner circumference across protective sleeve 500 may dynamically change by inserting more or less of bolts through bolt holes 520, allowing protective sleeve 500 to be coupled to different-sized mounts.

Cutout 530 may extend from the open outer face 504 towards the open inner face 502. Cutout 530 may be configured to allow wires associated with the sensor to be positioned through it. In embodiments, the cutout 530 may end before the bolt holes 520. This may enable the cutout 530 to not interfere with bolt holes 520.

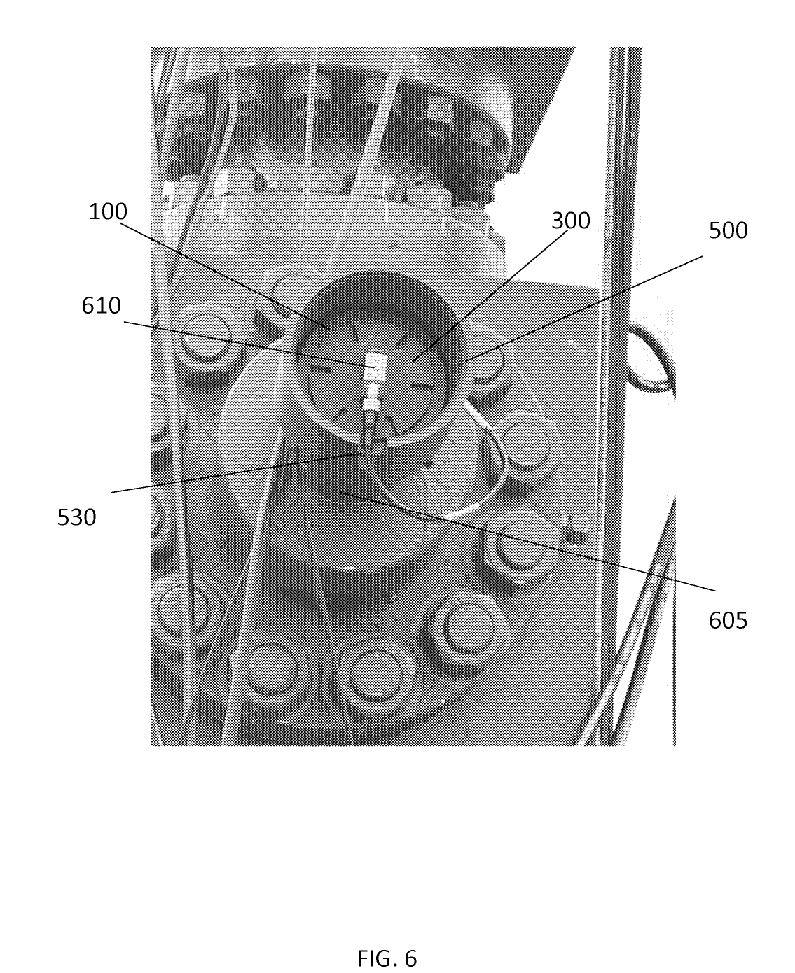

FIG. 6 depicts an embodiment of a mount 100, adapter 300, protective sleeve 500, and sensor 610, coupled to a protective stem housing 605. Elements depicted in FIG. 6 may be described above, and for the sake of brevity, a further description of these elements may be omitted.

As depicted in FIG. 6, mount 100 may be positioned over protective stem housing 605. Once mount 100 is positioned over protective stem housing 605, bolts extending in a radial direction may be utilized to decrease the inner circumference around mount 100 to couple mount 100 to protective stem housing 605.

After mount 100 is coupled to protective stem housing 605, adapter 300 may be secured to the outer and external surface of mount 100. Adapter 300 may be secured to mount 100 by threading a projection on the inner face of adapter 300 into a threaded groove within mount 100. This may position the inner face of adapter 300 flush with the outer surface of mount 100.

Subsequently, sensor 610 may be coupled to an exterior surface of adapter 300 by threading a projection associated with sensor 610 into a groove of adapter 300. This may couple a sensor 610 to the exterior of adapter 300.

Protective sleeve 500 may then be slid over the outer diameter of mount 100. Bolts extending in a radial direction may be utilized to decrease the inner circumference across the protective sleeve to couple Protective sleeve 500 to mount 100.

As depicted in FIG. 6, when sensor 610 is mounted to an exterior surface of adapter 300, wiring associated with sensor 610 may extend through groove 530 within the protective sleeve 500. Groove 530 may extend from a proximal end of protective sleeve 500 towards a distal end of protective sleeve 500, wherein the distal end is positioned closer to protective stem housing 605.

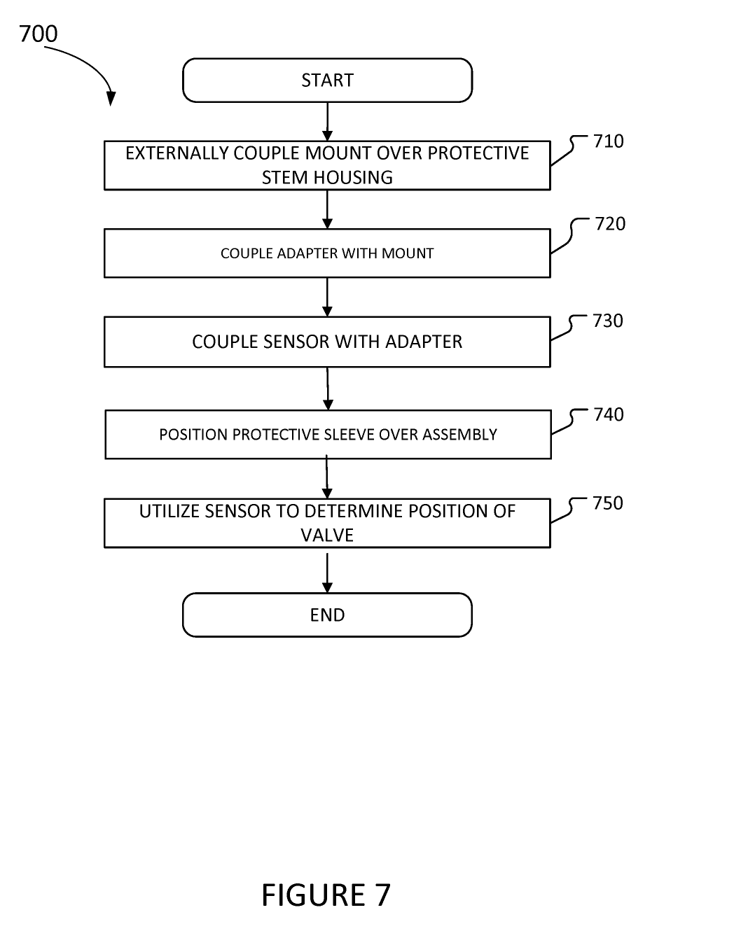

FIG. 7 illustrates a method 700 for allowing an adapter to be retrofitted on existing zipper manifolds via a mount, according to an embodiment. The operations of method 700 presented below are intended to be illustrative. In some embodiments, method 700 may be accomplished with one or more additional operations not described, and/or without one or more of the operations discussed. Additionally, the order in which the operations of method 700 are illustrated in FIG. 7 and described below is not intended to be limiting.

At operation 710, a mount may be coupled to a protective stem housing. The mount may be coupled by sliding a proximal end of the mount, having a smooth inner diameter, over a protective stem housing until the protective stem housing contacts a ledge within the mount. Bolts may then be inserted through bolt holes within the mount to dynamically decrease the inner diameter across the mount.

At operation 720, an adapter may be coupled to the mount by interfacing threads on the proximal end of the adapter with threads on the distal end mount.

At operation 730, a sensor may be coupled with the adapter by interfacing threads on the proximal end of the sensor with threads on the distal end of the adapter.

At operation 740, a protective sleeve may be slid over the protective stem housing, mount, adapter, and sensor. After the protective sleeve is slid over the assembly, bolts may extend through the protective sleeve to reduce the inner diameter across the protective sleeve to couple the protective sleeve to the assembly.

At operation 750, the sensor may emit a light through the assembly, wherein the emitted light may reflect off the upper surface of a stem of a gate valve, and return to the sensor. Based on a time delay from the emitted light until the light is received by the sensor, the sensor may determine a distance from the stem the sensor. This distance may indicate whether the gate valve is in an open or closed position.

Reference throughout this specification to "one embodiment", "an embodiment", "one example" or "an example" means that a particular feature, structure, or characteristic described in connection with the embodiment or example is included in at least one embodiment of the present invention. Thus, appearances of the phrases "in one embodiment", "in an embodiment", "one example" or "an example" in various places throughout this specification are not necessarily all referring to the same embodiment or example. Furthermore, the particular features, structures, or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Although the present technology has been described in detail for illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. An assembly configured to couple a sensor with a protective stem housing of a zipper manifold, the assembly including:
a mount with a smooth first inner diameter and a threaded second inner diameter, the smooth first inner diameter being configured to be positioned over the protective stem housing, the first inner diameter being larger than the threaded second inner diameter;
an adapter with a threaded proximal end, a flat distal end and a passageway, the threaded proximal end being configured to be interfaced with the threaded second inner diameter, the passageway extending from a proximal end of the adapter to the flat distal end, the passageway having a threaded distal end configured to receive a sensor, wherein the threaded proximal end is bulbous.

2. The assembly of claim 1, wherein the mount includes orifices, the orifices being configured to receive bolts to functionally reduce the first inner diameter in length.

3. The assembly of claim 2, wherein the mount includes a ledge that reduces the length of the first inner diameter towards the threaded second inner diameter.

4. The assembly of claim 1, wherein a length of threaded proximal end of the adapter is longer than a length of the threaded distal end of the passageway.

5. The assembly of claim 4, wherein an outer circumference of the adapter includes grooves.

6. The assembly of claim 1, wherein the first inner diameter and the second inner diameter of the mount are axially aligned.

7. The assembly of claim 6, further comprising:
a sensor being configured to be coupled to the threaded distal end of the passageway, and the passageway, the first inner diameter, and the second inner diameter define a channel to permit transmission of a signal between the sensor and a stem of a gate valve.

8. The assembly of claim 7, wherein the sensor is configured to emit a signal toward the stem of the gate valve through the adapter and the mount, receive a reflected portion of the signal from the stem, and determine whether the gate valve is in an open position or a closed position based at least in part on a time delay between emission and receipt of the signal.

9. The assembly of claim 1, wherein the mount is substantially tubular.

10. The assembly of claim 9, wherein the mount includes a tapered first end configured to guide the mount over the protective stem housing during installation.

11. The assembly of claim 1, further comprising:
a protective sleeve positioned over at least a portion of the mount.

12. The assembly of claim 11, wherein the protective sleeve includes radially oriented fasteners configured to secure the protective sleeve to the mount.

13. The assembly of claim 12, wherein the protective sleeve includes a cutout configured to route wiring associated with a sensor.

14. A method for determining a position of a gate valve, comprising:
coupling a mount to a protective stem housing of the gate valve;
coupling an adapter to the mount, coupling a sensor to the adapter;
emitting, by the sensor, a signal through the adapter and the mount toward a stem of the gate valve,
receiving, by the sensor, a reflected portion of the signal from the stem, and
determining whether the gate valve is in an open position or a closed position based on a time delay between emission of the signal and receipt of the reflected portion of the signal.

15. The method of claim 14, wherein coupling the mount to the protective stem housing comprises:
sliding the mount over the protective stem housing until the protective stem housing contacts an internal ledge of the mount.

16. The method of claim 15, further comprising:
securing the mount to the protective stem housing by tightening a plurality of radially oriented fasteners to reduce an effective inner diameter of the mount.

17. The method of claim 14, wherein coupling the adapter to the mount comprises:
threading a proximal end of the adapter into a threaded inner diameter of the mount.

18. The method of claim 14, wherein coupling the sensor to the adapter comprises:
threading the sensor into a threaded distal end of the adapter.

19. The method of claim 14, wherein emitting the signal comprises:
transmitting an optical signal through an internal passageway of the adapter and the mount toward an upper surface of the stem.

20. The method of claim 14, wherein determining whether the gate valve is in the closed position comprises:
determining that the time delay exceeds a first threshold.
